(19) United States
(12) Patent Application Publication
(10) Pub. No.: US 2026/0165299 A1
(43) Pub. Date: Jun. 18, 2026

(54) PET LEASH WITH INTEGRATED WASTE BAG HOLDERS

(71) Applicant: Joseph Hudicka, Princeton, NJ (US)

(72) Inventor: Joseph Hudicka, Princeton, NJ (US)

(21) Appl. No.: 19/336,483

(22) Filed: Sep. 22, 2025

Related U.S. Application Data
(60) Provisional application No. 63/697,461, filed on Sep. 21, 2024.

(51) Int. Cl. A01K 27/00; E01H 1/12

(52) U.S. Cl. CPC A01K 27/008; A01K 27/001; A01K 27/004; A01K 27/005; A01K 27/006; E01H 1/1206

(57) ABSTRACT

A double S-shaped clip device attaches to a pet leash via a tri-glide weaving mechanism for adjustable securing. The device features a bag loop or hole for holding unused waste bags and a heavy bag clip with securing nubs and a hook for used bags. Made from durable plastic, it accommodates various leash types, includes optional decorative molding like animal shapes, and enables hands-free waste management. The structure ensures stability, hygiene, and convenience during walks, with alternatives for materials, sizes, and add-ons.

### CROSS-REFERENCE TO RELATED APPLICATIONS

This application claims priority to U.S. Provisional Ser. No. 63/697,461 filed on 21 Sep. 2024 entitled “Dog Walking Augmentation,” the entire contents of which are incorporated herein by reference.

### BACKGROUND OF THE INVENTION

### Field of the Invention

The invention relates generally to pet accessories.

### PROBLEM STATEMENT AND HISTORY

### Interpretation Considerations

This section describes technical field in detail and discusses problems encountered in the technical field. Therefore, statements in the section are not to be construed as prior art.

### DISCUSSION OF HISTORY OF THE PROBLEM

Dog owners frequently encounter the challenge of managing pet waste during routine walks. One common method involves carrying disposable plastic bags for collecting dog feces. However, this method presents several inconveniences. The owner must carry the waste throughout the remainder of the walk, which can be unpleasant and unhygienic. Additionally, plastic bags contribute to environmental waste, as they are often non-biodegradable, leading to concerns about long-term ecological impacts.

Another method involves the use of pooper scoopers, designed to collect and store dog waste temporarily. While these devices prevent direct contact with the waste, they are often bulky and inconvenient to carry, especially during longer walks. Furthermore, many pooper scoopers require manual cleaning after use, creating additional maintenance burdens for the owner. This combination of size, weight, and post-use cleaning diminishes their practicality for daily walks.

Public waste bins provide a disposal option for some dog owners; however, these bins are not always available in many walking areas, forcing owners to carry the waste over longer distances. In densely populated urban areas, these bins may become overwhelmed, leading to sanitation issues or even littering. Additionally, areas without designated bins leave owners without an immediate disposal option, increasing the likelihood of improper disposal.

Biodegradable bags have been introduced as a more environmentally friendly alternative to traditional plastic bags. However, they are still subject to the same issues of carrying and handling waste during the walk. Furthermore, the degradation process may take years under typical landfill conditions, limiting their true ecological benefit. Inconsistent manufacturing standards also mean that many “biodegradable” bags do not decompose as efficiently as claimed.

Consequently, there remains a need for a more efficient, hygienic, and eco-friendly method of collecting and disposing of dog waste during walks. A solution that addresses the logistical challenges of waste handling, disposal access, and environmental concerns could greatly improve the experience for dog owners while promoting responsible pet ownership, and the present invention provides such an invention.

### SUMMARY OF THE INVENTION

The invention provides a double S-shaped clip device for attaching to a pet leash, functioning as a tri-glide for secure, adjustable weaving attachment. The device includes a serpentine frame with a tri-glide assembly comprising a bridge and gaps for leash weaving, an empty bag-holding element such as a hole or loop for unused bags, and a heavy bag clip with securing nubs and a tongue for holding used bags. Constructed from durable materials like plastic, the device accommodates various leash types, offers decorative molding options, and enables hands-free operation. Benefits include enhanced stability, hygiene, convenience, and customization for responsible pet ownership.

### BRIEF DESCRIPTION OF THE DRAWINGS

Various aspects of the invention and its embodiment are better understood by referring to the following detailed description. To understand the invention, the detailed description should be read in conjunction with the drawings, in which:

FIG. 1 is a perspective view of the clip device, illustrating the double S-shaped frame, tri-glide components, bag loop, heavy bag clip with securing nubs, and other structural elements.

FIG. 2 is a front elevational view of the clip device, showing decorative elements such as stylized eyes, eyebrows, and pupils integrated into the frame.

FIG. 3 is a rear elevational view of the clip device, depicting the utilitarian double S-shaped profile.

### DESCRIPTION OF AN EXEMPLARY PREFERRED EMBODIMENT

### Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### DESCRIPTIONS OF THE DRAWINGS AND EXEMPLARY EMBODIMENT

The present invention relates to a double S-shaped clip device 100 designed to assist pet owners in carrying used and unused dog waste bags during walks. The device is adaptable to various leash styles and materials, and may also serve a decorative function, providing both utility and aesthetic appeal. In operation, the clip functions like a tri-glide clip, with the pet leash weaving between parallel portions of the clip for adjustable, friction-based securing, while retaining its distinctive double S-shaped profile for ergonomic and visual purposes.

In its preferred embodiment, the clip device 100 comprises a double S-shaped clip made from a durable material, preferably plastic (e.g., injection-molded ABS or nylon), though other materials such as metal, rubber, or composite materials may be used. The clip is approximately 2 inches wide and 3 inches long, though these dimensions may vary depending on the size of the leash or specific purpose of the clip device 100, and the preferences of the user.

In an S-configuration, the clip device 100 includes two primary ends: top frame member 105 and tongue 142 as exterior portions of the double S-shaped configuration. The interior members of the clip device 100 (first frame member 115, bridge 120, and second frame member 130) are adapted to attach to a strap or leash. The tongue 142 is adapted to receive and hold doggie waste bags.

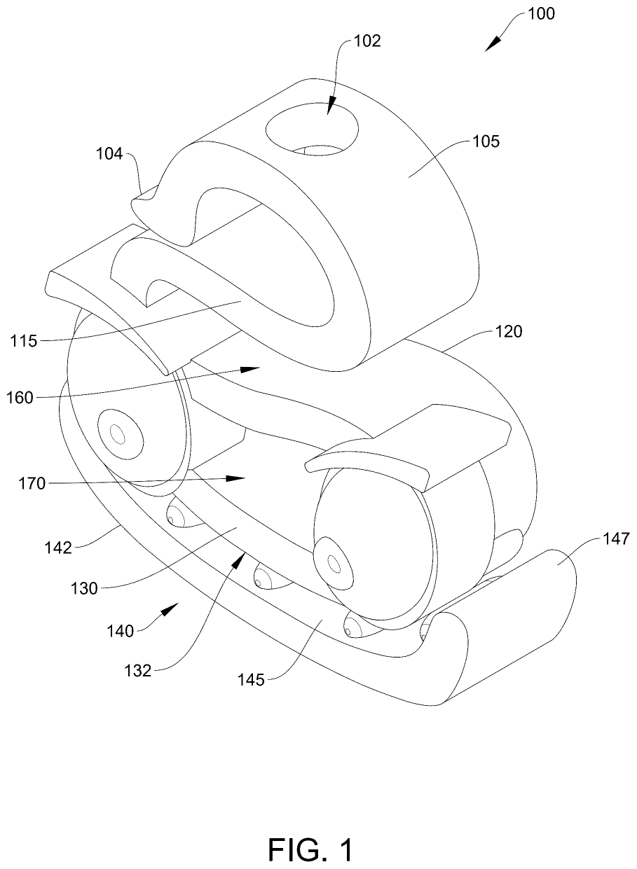

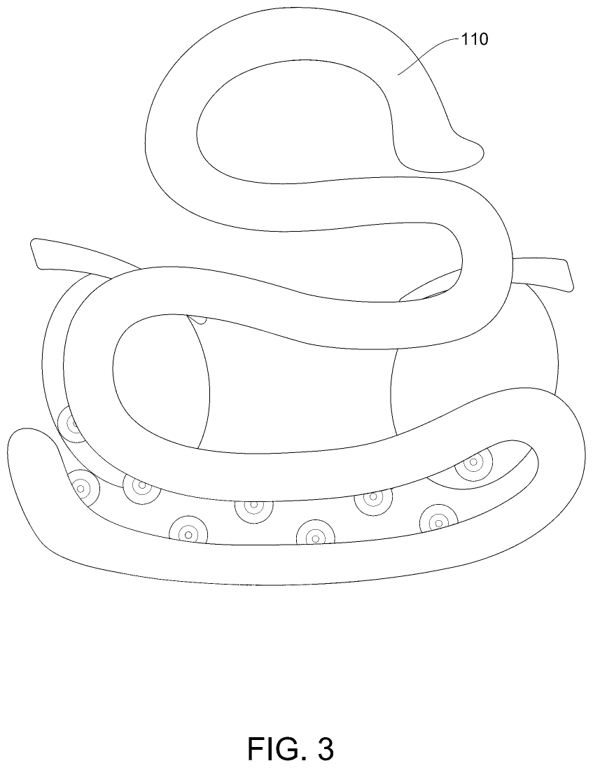

The double S-shaped structure, as illustrated in FIGS. 1-3, forms a continuous, serpentine frame 110 (most clearly seen via FIG. 3) with curved features that allow the clip device 100 to attach securely to a pet leash (which functions as a strap in the context of a tri-glide clip) while providing additional points of attachment for holding empty dog waste bags and used doggie bags.

This shape defines three functional assemblies.

The first assembly is functionally a tri-glide clip comprising a bridge 120, and a frame comprising a first frame member 115 and a second frame member 130. The first frame member 115 is, relative to the clip device 100, a top interior member, while the second frame member 130 is a bottom interior portion of the clip device 100. The second frame member 130 doubles as a portion of an integrated heavy-bag clip 140.

A first gap 160 is defined between the first frame member 115 and the bridge 120, and a second gap 170 is defined between the bridge 120 and the second frame member 130.

One or more of the surfaces of the first frame member 115, the bridge 120, and the second frame member 130 (collectively, “the tri-glide clip surfaces”) may be textured to engage with the fibers or leather of a pet leash or strap, preventing slippage and ensuring the clip remains securely attached to the leash throughout the walk or other usage. In an alternative embodiment, one or more of the tri-glide clip surfaces may also include nubs for gripping a leash ensuring the clip device 100 does not slip during usage.

The resulting openings enable strap passage for weaving, enhancing stability. For leashes made of more delicate materials, such as leather, the clip may feature a non-scratching gripping mechanism. This mechanism may take the form of a smooth surface, rubberized coating on the nubs, or a buckle attachment, designed to avoid damaging or scratching the leash while still providing a secure hold. The design ensures compatibility with a wide range of leash types, from traditional nylon and leather leashes to retractable models.

The entire structure of the clip device 100 features a self-spring-loaded mechanism (mimicked through material flexibility) which allows the clip device 100 to maintain tension and securely grip both a strap or leash and bags or other items attached thereto without manual adjustment. The spring-loaded nature of the clip, combined with the tri-glide weaving, ensures that it can flexibly accommodate different leash thicknesses (e.g., 0.25-1 inch) and bag sizes.

A second assembly is an empty bag-holding element, here shown as a hole 102 in a top frame member 105 that is also called a bag loop. In practice, a set of small plastic bags may be tied in a knot such that the empty bags may pass through the hole 102, while the knot is unable to pull through the hole. In another embodiment, the bags are integrated in a manner similar to grocery shopping bags (which share a tab with perforations such that the bags can pull through the hole 102 but the tab will not).

In yet another embodiment, the empty doggie bags may be embodied such that they are pre-attached to an apparatus that attaches to the hole 102, including a tapered plug/tapered pin embodied as a friction-fit cone or wedge, a rivet (removable type) which is sometimes called a push rivet or plastic rivet particularly if it has a conical shank that snaps in and holds, an expansion plug/ expansion fastener—particularly if the conical shape spreads or flares to grip the hole walls, or a push-in clip/push pin—which is a common name in plastics and automotive hardware for conical “Christmas tree” style clips. Accordingly, unused bags (e.g., rolled dispensers) can be secured via top frame member 105 functioning as a bag loop (and securable via flaring tip 104) or via supplies receiving hole 102 (a top-mounted aperture in element 105 for dispenser attachment). In this way, the clip reduces the inconvenience of carrying waste bags, enhancing the overall walking experience for the dog owner while preventing dangling or spillage.

The third assembly is a heavy bag clip 140 comprising a lower jaw 142 and an upper palate 132 of the second frame member 130. The second frame member comprises a plurality of gripping teeth (aka “securing nubs”) 241, 242, 243, 244, 245, 246, and 248. The securing nubs 241, 243, and 245 are positioned on the surface of the palate 132 to ensure a firm grip on a heavy (full or used) doggie bag. Similarly, securing nubs 242, 244, 246, and 248 are secured to or integrated with the tongue 145 of the heavy bag clip 140 to likewise secure a grip on the heavy doggie bag. The tongue 145 portion of the serpentine frame 110 terminates in an upward-bending hook 147 to additionally secure the heavy doggie bag in the heavy bag clip 140.

Accordingly, the heavy bag clip 140 grips heavy bags, ensuring they are held firmly in place until disposal. The clip device 100 is designed via the heavy bag clip 140 to hold the bags by their tied ends or handles, using its spring-loaded mechanism and frame tension to keep them securely in place. When the owner collects the dog waste, the used bag can thus be attached to the heavy bag clip 140, freeing the owner's hands for the remainder of the walk.

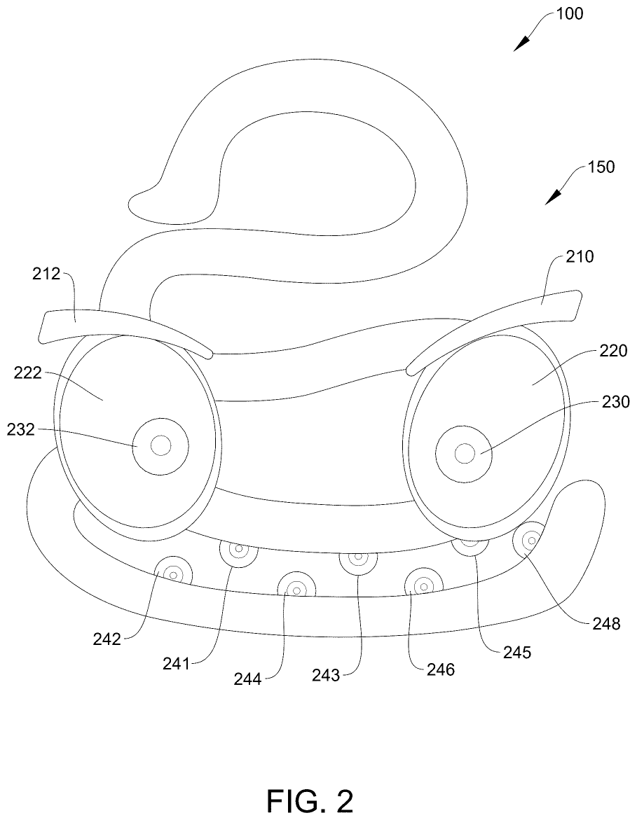

In addition to its practical functionality, the clip may be designed with a decorative purpose. In one embodiment, as depicted in FIGS. 2-3, the clip may be molded into the shape of an insect, animal (e.g., “heavy dog chap” for a stylized dog face), or cartoon figure, giving it an ornamental appearance through elements like optional ornamental element 150, comprising left eye 222, right eye 220, left eyebrow 212 and right eyebrow 210, as well as right pupil 230 and left pupil 232. From the back, the clip may have a utilitarian-appearing double S-shaped profile while featuring a decorative emblem or logo attached to one or both ends (e.g., on top fix 109). This decorative aspect provides an opportunity for customization, allowing dog owners to choose a clip that reflects their personal style or adds a playful element to their dog's leash.

While plastic is the preferred material for the clip due to its durability, flexibility, and ability to be molded into various shapes, the invention is not limited to plastic. Other materials, such as lightweight metals, composites, or rubber, may be used depending on the desired appearance and functionality. The spring-loaded mechanism may vary in strength and size, depending on the type of leash and bags it is designed to accommodate, and may include additional palatal elements (such as internal ridges) for enhanced friction. The clip may also be produced in multiple sizes to suit different dog or other animal breeds and leash dimensions. In alternative uses, the invention could function as holder for a bag of chips in a pantry, where multiple of the clip devices 100 could be used to hang bags of chips or puffs from a single strap.

The invention is suitable for use with a variety of leash types, including standard leashes, retractable leashes, and even specialized training leashes. The adaptability of the clip's gripping mechanism ensures that it can be securely attached to leashes of different materials, thicknesses, and designs.

In operation, a user weaves a leash strap through the double S-shaped tri-glide clip as is known to those of skill in the mechanical arts upon reading this disclosure. Typically this is accomplished by first weaving the strap into the first gap 160 from behind the ornamental feature 150, across the bridge 120, and then back through the second gap 170 to exit the back-side of the clip device 100, or by weaving the strap in the opposite manner, and adjusting the strap/leash position via cinching with friction and the tension force of the strap itself.

This configuration removably secures the clip device 100 to the leash without permanent attachment. Unused bags attach to bag loop 105 and perhaps via the bag receiving hole 102, while post-use, tied bags are secured to the clip device 100 via the heavy bag clip 140. This hands-free setup allows focus on the dog, with the device's lightweight (˜1-3 oz) preventing leash imbalance. For decorative embodiments (FIG. 3, back view), the S-curved frame enhances aesthetics without compromising function. Retractable leashes integrate via the adjustable weave, and variants include multiple additional bag loops (not shown) for larger breeds or additional storage.

Alternative embodiments include non-scratching surfaces (smooth polymer) for delicate leashes, reinforced bridges for heavy-duty use, or modular add-ons (e.g., LED for visibility). The invention encompasses all equivalents achieving similar strap-securing and bag-holding functions, including variations in loop sizing or materials as technology advances.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention all such variations and departures that fall within the scope of the appended claims and equivalents thereof.

I claim:

1. A pet leash attachment device comprising:
a double S-shaped frame with a tri-glide assembly including a bridge and gaps for leash weaving;
a bag loop for unused bags; and
a heavy bag clip with securing nubs for used bags.

2. The device of claim 1, wherein the frame comprises a top frame member with a hole for receiving unused bag dispensers.

3. The device of claim 1, wherein the heavy bag clip includes a tongue terminating in an upward-bending hook and a palate with a plurality of securing nubs.

4. The device of claim 1, wherein the tri-glide assembly includes a first gap between a first frame member and the bridge, and a second gap between the bridge and a second frame member.

5. The device of claim 1, wherein surfaces of the tri-glide assembly are textured or include nubs for gripping the leash.

6. The device of claim 1, further comprising a non-scratching gripping mechanism selected from a smooth surface or rubberized coating.

7. The device of claim 1, wherein the device is formed from plastic material.

8. The device of claim 1, wherein the device is approximately 2 inches wide and 3 inches long.

9. The device of claim 1, further comprising decorative elements molded into the frame, such as an animal or cartoon figure.

10. The device of claim 9, wherein the decorative elements include eyes, eyebrows, and pupils on a front surface.

11. The device of claim 1, wherein the frame provides a self-spring-loaded mechanism through material flexibility.

12. The device of claim 1, adapted for attachment to nylon, leather, or retractable leashes.

13. The device of claim 1, further comprising modular add-ons such as an LED light.

14. A method of using the device of claim 1, comprising weaving a leash through the gaps, securing unused bags in the bag loop, and attaching used bags to the heavy bag clip.

15. The device of claim 1, wherein the bag loop accommodates knotted bags, perforated tabs, or attachment apparatuses such as tapered plugs or push rivets.
